(19) United States
(12) Patent Application Publication
(10) Pub. No.: US 2007/0201129 A1
(43) Pub. Date: Aug. 30, 2007

(54) Inverted Microscope

(76) Inventors: Oliver Jagemann, Gottingen (DE); Bernard Kleine, Linden (DE); Arnd Sauer, Ehringshausen (DE)

Correspondence Address: SIMPSON & SIMPSON, PLLC, 5555 MAIN STREET, WILLIAMSVILLE, NY, 14221-5406, US

(21) Appl. No.: 11/632,678

(22) PCT Filed: Jul. 6, 2005
(86) PCT No.: PCT/EP05/53237

§ 371 Date: Jan. 17, 2007

(30) Foreign Application Priority Data
Jul. 19, 2004 (DE) 10 2004 034 848.0

(51) Int. Cl. G02B 21/00

(52) U.S. Cl. 359/368

(57) ABSTRACT

An inverted microscope that follows an innovative and ergonomic user concept so that a user can properly operate the motorized inverted microscope using the plurality of the control buttons present on the stand even without visual contact. In particular, a plurality of control buttons for operating the motorized microscope functions is provided on the first, second and front faces, the control buttons being brought together into a plurality of groups, each group comprising a plurality of control buttons at least some of which are proved near a tactile element as an aid for user orientation. More particularly, the object of the invention is achieved via an inverted microscope described as follows: An inverted microscope of the invention has a base stand part, which carries a lens turret and a microscope stage, and, furthermore, on which base part a lighting stand part is mounted. The base stand part has a first lateral face, a second lateral face and a front intended to face a user. A plurality of control buttons for the control of motorized microscope functions is provided on the first and second lateral faces and the front face. The control buttons are arranged into a plurality of groups, each comprising a plurality of control buttons. The control buttons are arranged into a first group, a second group, a third group, a fourth group and a fifth group where the control buttons of the second group are arranged on the first lateral face around a tactile element that serves as an orientation aid to the user, and the control buttons of the third group are arranged on the front face, likewise around a tactile element that serves as an orientation aid to the user.

### BACKGROUND OF THE INVENTION

The invention relates to an inverted microscope. In particular, the invention relates to an inverted microscope having a base part that carries a lens turret and a microscope stage. In addition, a lighting stand part is mounted on the base stand part. The base stand part has a first lateral face, a second lateral face and a front that faces the user.

U.S. Pat. No. 5,000,555 discloses the arrangement of control buttons on an upright microscope. There are three control buttons provided here behind the focus knob for the microscope stage, their arrangement being configured in such a manner that they are within the actuation range of a user's hand when the user is operating the focus knob. Furthermore, a keyboard is assigned to the microscope with which the user can allocate various functions to the control buttons. This keyboard can be slid under the microscope stand.

A brochure of Leica Microsystems CMS GMBH for Leica DM4000 B and Leica DM5000 B microscopes likewise describes an upright microscope. Provided on the microscope stand for the improvement of the stability are wings that are arranged behind the focus knob. Provided on the stand wings, and therefore also behind the focus knob, to the left and right is a plurality of control buttons. Likewise, a group of control buttons is provided on the lateral face of the stand with which the user light and aperture adjustments can be made. However, this group of control buttons lacks a tactile element with which to enable a user to have an orientation within the group even without visual contact with the control buttons.

U.S. patent publication US 2002/0041438 discloses an inverted microscope. The inverted microscope has a display incorporated on the front of the stand that can be swiveled somewhat in its angular position so that the user can better view it. The inverted microscope illustrated here does not disclose the display in an extension of the base part of the stand, and furthermore, no control buttons on the first or second lateral wall of the stand of the inverted microscope are mentioned.

German Patent Application DE 42 31 470 A1 discloses a modular microscope system. Provided below the focus knob is a filter module, which has provided a plurality of sliding elements in a linear arrangement parallel to the placement surface of the microscope. Likewise, in the stand base part or in the front part of the foot of the stand a display is provided from which the user can read microscope settings. A tactile aid for actuating the slider or the pressing element of the microscope is not discussed in the unexamined patent application.

German application DE 101 06 275 A1 discloses an arrangement and a method for the control and/or display of microscope functions. The arrangement is preferably an inverted microscope, a display, which is advantageously removable, being provided at eye level or in the vicinity of eye level of a person using the microscope. The setting and/or memorization of microscope functions can be made using the display.

U.S. patent publication US 2003/0090789 A1 discloses a microscope having several multifunctional control elements. A plurality of electrically controllable components of a microscope, such as lens turrets, filter turrets, diaphragms, focus, illuminating fixtures, etc., can be operated using the multifunctional control elements. The plurality of microscope functions that are controllable by the control buttons for the most part exceeds the number of control buttons that are available and placed on the microscope. Therefore, any function of the microscope can be set on any control button. The microscope presented in the patent publication has a plurality of control buttons distributed on the stand that are arranged in groups. Thus, one group is located, for example, behind the focus knob, two other groups are arranged in front of the focus knob. In addition, a single focus knob is provided on the front of the microscope. Nothing is mentioned in the patent publication regarding a tactile aid for the reliable location of the control buttons.

### BRIEF DESCRIPTION OF THE INVENTION

The object of the invention is to create an inverted microscope that follows an innovative and ergonomic user concept so that a user can properly operate the motorized inverted microscope using the plurality of the control buttons present on the stand even without visual contact.

In particular, a plurality of control buttons for operating the motorized microscope functions is provided on the first, second and front faces, the control buttons being brought together into a plurality of groups, each group comprising a plurality of control buttons at least some of which are proved near a tactile element as an aid for user orientation. More particularly, the object of the invention is achieved via an inverted microscope described as follows:

An inverted microscope of the invention has a base stand part, which carries a lens turret and a microscope stage, and, furthermore, on which base part a lighting stand part is mounted. The base stand part has a first lateral face, a second lateral face and a front intended to face a user. A plurality of control buttons for the control of motorized microscope functions is provided on the first and second lateral faces and the front face. The control buttons are arranged into a plurality of groups, each comprising a plurality of control buttons. The control buttons are arranged into a first group, a second group, a third group, a fourth group and a fifth group where the control buttons of the second group are arranged on the first lateral face around a tactile element that serves as an orientation aid to the user, and the control buttons of the third group are arranged on the front face, likewise around a tactile element that serves as an orientation aid to the user.

### BRIEF DESCRIPTION OF THE DRAWINGS

FIG. 1 a perspective view of an embodiment of an inverted microscope in which the subject matter of the invention is realized;

FIG. 2 a front view of the inverted microscope;

FIG. 3 a side view of the first lateral face of the inverted microscope;

FIG. 4 a side view of the second lateral face of the inverted microscope;

FIG. 5 a detail view of the second group of control buttons on the first lateral face of the inverted microscope; and

FIG. 6 a detail view of the third group of control buttons on the front face of the inverted microscope.

FIG. 7 a sectional view through the tactile element that is formed on the first lateral face of the base part of the inverted microscope.

### DETAILED DESCRIPTION OF THE INVENTION

The invention has the advantage that the base part of the inverted microscope has a first lateral face, a second lateral face and a front that faces the user. A plurality of control buttons for the operation of motorized microscope functions is provided on the first, second and front faces. The control buttons are brought together in a first group, in a second group, in a third group, in a fourth group and in a fifth group. The control buttons of the second group on the first lateral face are arranged around a tactile element. Likewise, the control buttons of the third group are arranged on the front face around a tactile element.

The first group of control buttons comprises four control buttons that are arranged in an arc behind a focus knob situated on an axial spindle. Therefore, two of the four control buttons are arranged on the first lateral face above the spindle axis and two of the control buttons are arranged on the first lateral face below the spindle axis.

The control buttons of the fifth group are likewise arranged in an arc behind the focus drive knob situated on the spindle. Therefore, two of the three control buttons are arranged on the second lateral face above the spindle axis and one control button is arranged on the first lateral face below the spindle axis.

The fourth group comprises three control buttons that are arranged in a straight line and vertically in front of the focus drive knob situated on the spindle. Two of the three control buttons are arranged on the second lateral face below the spindle axis.

The tactile element assigned to the second group is configured as a recess. In this context, it is especially advantageous if the recess has the shape of a spherical segment. At least four of the control buttons are arranged in a cruciform configuration around the tactile element, at least two control buttons being arranged on a vertical leg of the cross and two of the control buttons being arranged on a horizontal leg of the cross.

It is especially advantageous if on the horizontal leg of the cross an initial pair of control buttons is arranged to the left of the tactile element and a second pair of control buttons is arranged to the right of the tactile element at a distance. On the vertical leg of the cross, a third pair of control buttons is arranged above the tactile element and a single control button is arranged below the tactile element at a distance. A setting point of the microscope can be increased by pressing one control button of the first pair, the second pair or the third pair. The corresponding setting point of the microscope can be decreased by pressing the other control button of the first pair, the second pair or the third pair. The aperture diaphragm can be enlarged or reduced using the first pair of control buttons. The field of view stop can be enlarged or reduced using the second pair of control buttons. The light intensity can be increased or decreased using the second pair of control buttons. The single control button is configured as a toggle switch with which it is possible to switch between the different types of illumination for the microscope.

The control buttons of the third group are arranged on the front face of the microscope within an essentially rectangular plate. The tactile element of the third group is a control button that is arranged essentially in the region of the intersection of the diagonal rectangular plate. The tactile element is the control button for a shutter. A pair of control buttons is arranged diagonally to the left above the tactile element. The first pair of control buttons is used to switch between a plurality of ports of the microscope. Likewise, a pair of control buttons is arranged diagonally to the right above the tactile element. The pair of control buttons is used for switching between magnification and/or reduction. Three control buttons are arranged diagonally to the right below the tactile element and likewise three control buttons are arranged diagonally to the left below the tactile element. Each of the control buttons arranged diagonally to the left below or diagonally to the right below the tactile element is used for the selection of a filter cube at a specific position. The filter cubes are arranged on a wheel having six positions.

The base part of the inverted microscope has a wedge-shaped extension below the third group of control buttons on the front. A display is incorporated in the wedge-shaped extension. The display is firmly installed and tilted at an angle <45° relative to a placement surface of the inverted microscope.

Additional advantageous embodiments of the invention can be derived from the subclaims and the description given below.

In the drawings, the subject matter of the invention is diagrammatically illustrated and is described below in relation to the figures.

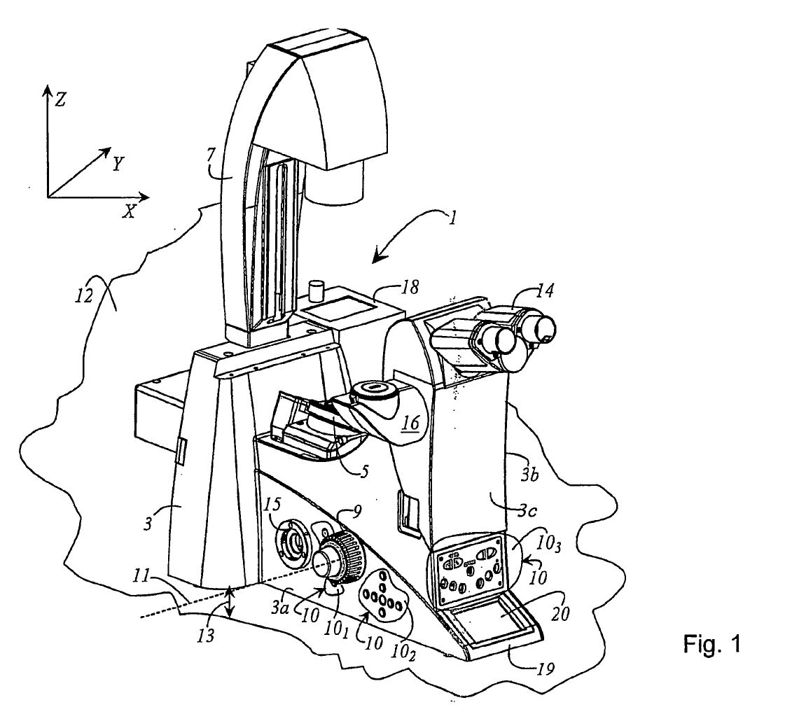

FIG. 1 shows a perspective view of the inverted microscope 1 in which the subject matter of the invention is realized. Inverted microscope 1 comprises a base part 3, which carries a lens turret 5 and a microscope stage (not depicted). The base part 3 has a first lateral face 3a and a second lateral face 3b. Furthermore, a front face 3c that faces a user (not shown) is formed. A lighting stand part 7, which provides the necessary light intensity for the investigation of a specimen or specimen container that is present on a microscope stage, is mounted on base part 3.

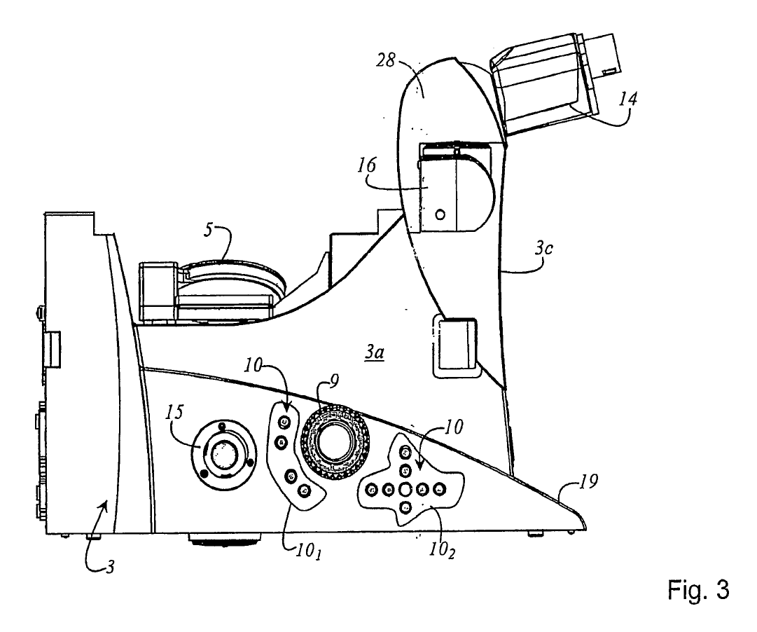

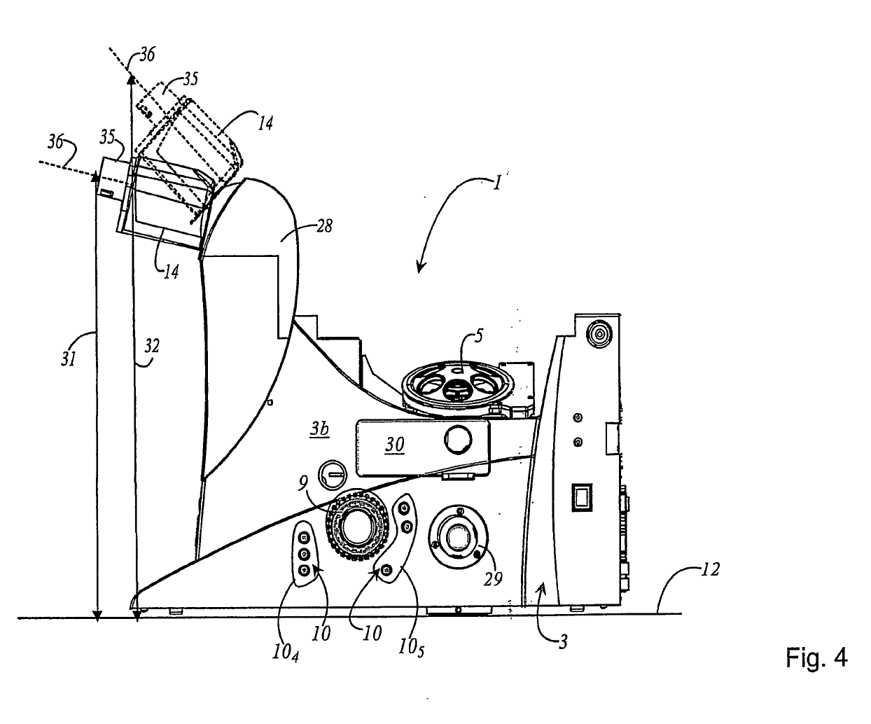

A plurality of control buttons for the actuation of motorized microscope functions is provided on first and second lateral faces 3a and 3b and front face 3c. Control buttons 10 are brought together in a plurality of groups each of which comprises a plurality of control buttons. According to the present invention, a first group 10₁, a second group 10₂, a third group 10₃, a fourth group 10₄ and a fifth group 10₅ are provided on base part 3a of inverted microscope 1. An accurate view of the arrangement of first group 10₁, and second group 10₂ is recognizable from the side view of FIG. 3, and the exact arrangement of fourth group 10₄ and fifth group 10₅ is recognizable from the side view of FIG. 4.

On base part 3 of inverted microscope 1, a focus drive knob 9 is arranged on both sides of first lateral face 3a and second lateral face 3b. Focus drive knob 9 is mounted to be rotatable about spindle axis 11. The focus drive knobs or axis 11 of focus drive knobs 9 is [sic] arranged here with respect to a placement surface 12 of the microscope in such a manner that it is possible to work with inverted microscope 1 in a relaxed manner. Furthermore, focus drive knobs 9 are ergonomically configured in such a manner that it is possible to work comfortably. The diameter and the shape of focus drive knobs 9 are adapted here to an average user hand size.

Base part 3 of inverted microscope 1 is provided with an eyepiece 14 on front face 3. In addition, base part 3 of inverted microscope 1 has a plurality of ports 15, 16, 17. Likewise, there is on base part 3 an illuminating fixture 18 with which the light can be fed into inverted microscope 1 for the illumination of a specimen (not shown), etc. Within the area of third group 10₃, base part 3 has a wedge-shaped extension 19. Incorporated into wedge-shaped extension 19 is a high-resolution display 20. In this way the user obtains at a glance all information related to the setting of inverted microscope 1.

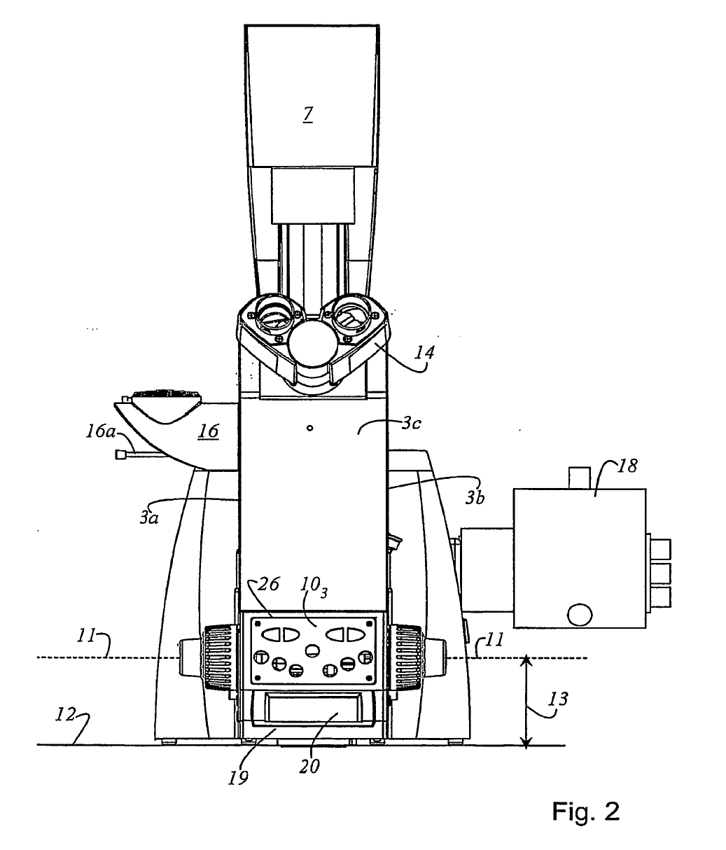

FIG. 2 shows a front view of the inverted microscope of the invention. As already mentioned in the description for FIG. 1, lighting stand part 7 is placed on base stand part 3. Provided on front face 3c of base stand part 3 is eyepiece 14 and third group 10₃ of control buttons 10. Focus knobs 9 are arranged on first lateral face 3a and second side face 3b of base stand part 3. As already mentioned, distance 13 of axis 11 of the focus knobs from placement surface 12 of the inverted microscope is sized in such a manner that focus knobs 9 can also be operated well by a user having an average hand size. The arrangement of third group 10₃ of control buttons 10 is coordinated with the arrangement of focus knobs 9 on first lateral surface 3a or second lateral surface 3b in such a manner that axis 11 of control knobs 9 runs approximately through the center of rectangular plate 26 on which control buttons 10 of third group 10₃ are arranged. Furthermore, tube outlet 16 is attached to first lateral surface 3a of base stand part 3. Provided on tube outlet 16 is a push/pull bar 16a with which a plurality of optical elements can be placed in the illuminating beam of inverted microscope 1. Illuminating fixture 18 is placed on the second lateral face 3b of base stand part 3. Light of many different wavelengths and/or composition can be fed into the illuminating beam of inverted microscope 1 via illuminating fixture 18. As previously mentioned, display 20 is inserted on wedge-shaped extension 19 of base stand part 3. Therefore, inclination of display 3 relative to placement surface 12 of the inverted microscope is not >45°.

FIG. 3 shows the side view of first lateral surface 3a of inverted microscope 1. Focus knob 9, which is rotatable about axis 11, is arranged on first lateral surface 3a. Provided to the left of the focus knob is first group 10₁ of control buttons 10, and arranged to the right of control knob [sic] 9 is the second group 10₂ of control buttons 10. The user can assign different motorized microscope functions to control buttons 10 of first group 10₁. Front face 3c of the base stand part 3 runs essentially vertically between the wedge-shaped extension 19 of base stand part 3 and eyepiece 14. A cover 28 covers the area between third group 10₃ of the control buttons and eyepiece 14 and also parts of first lateral face 3a and second lateral face 3b. Cover 28 has a cutout for tube outlet 16. Port 15 is arranged behind first group 10₁ of control buttons 10. Turret 5 is attached above port 15.

FIG. 4 shows a side view of second lateral face 3b of base stand part 3. Arranged to the left of focus knob 9 is fourth group 10₄ of control buttons 10. The arrangement of fourth group 10₄ of control buttons 10 is vertical and linear on second lateral face 3b of base stand part 3. Control buttons 10 of fourth group 10₄ are used to adjust the focus position. The arrangement of the control buttons of fourth group 10₄ indicates their functionality. The top control button adjusts turret 5 upward in the Z-direction. The bottom control button adjusts turret 5 downward in the Z-direction. The center control button of fourth group 10₄ is used to move anew into a preset position of turret 5 in the Z-direction. Arranged to the right of focus knob 9 is fifth group 10₅ of control buttons 10. Control buttons 10 of fifth group 10₅ can also be assigned by the user with different motorized microscope functions. Likewise, another port 29 is integrated in second lateral face 3b of base stand part to the right of fifth group 10₅ of the control buttons.

As already mentioned several times, lens turret 5 is carried by base stand part 3. On second lateral surface 3b of base stand part 3, a flap 30 is provided between port 29 and lens turret 5 through which it is possible to access the filter wheel (not shown). Tube 14 that is provided on inverted microscope 1 is formed as an ergo tube. The ergo tube can be used to adjust the viewing height of the user. The viewing point of eyepiece 35 is defined by optical axis 36 of eyepiece 35. The adjustment of tube 14 thereby allows a change of viewing height 32 from 409 mm to a viewing height 31 of 502 mm. The viewing height is the distance from optical axis 36 of the eyepiece to placement surface 12 of inverted microscope 1. The adjusted position (viewing height 502 mm) of tube 14 is designated by dashed lines in FIG. 4.

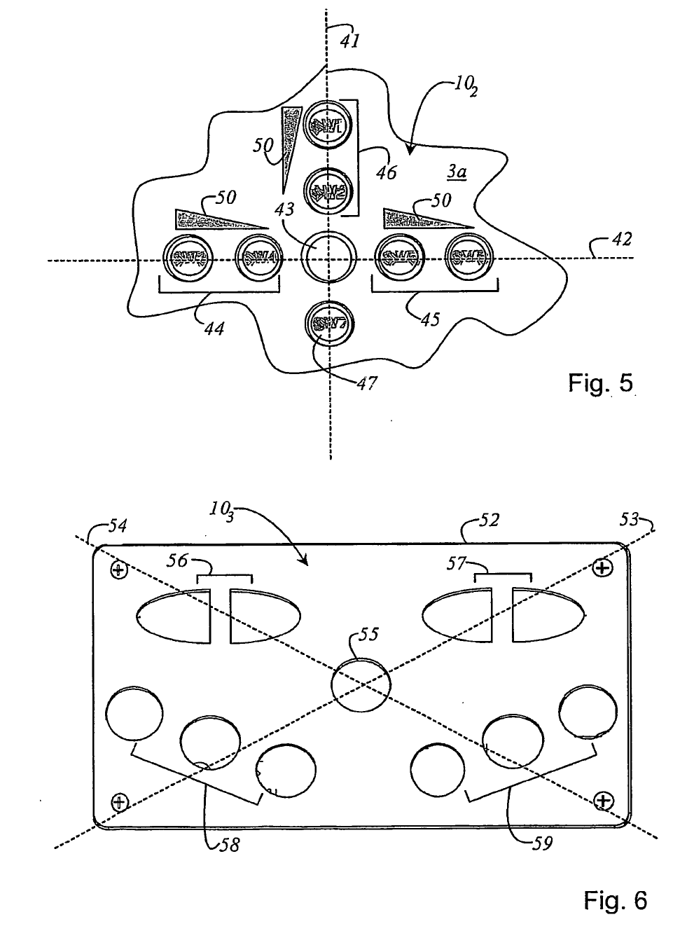

FIG. 5 shows a detail view of second group 10₂ of control elements 10. Control buttons 10 of second group 10₂ are arranged on a vertical leg 41 and a horizontal leg 42 of a cross. At the intersection point of vertical leg 41 and horizontal leg 42, a tactile element 43 is formed in first lateral face 3a of base part 3. On horizontal leg 42, a first pair 44 of control buttons is arranged to the left of tactile element 43, and a second pair 45 of control buttons 10 is arranged to the right of tactile element 43. On vertical leg 41 of the cross, a third pair 46 of control buttons 10 is arranged above tactile element 43, and a single control button 47 is arranged below the tactile element. Tactile element 43 serves as an orientation aid for the user. Control buttons 10, which are arranged in pairs, are wired here in such a manner that a setting point of inverted microscope 1 can be increased by operating one of the control buttons arranged in a pair, and the corresponding setting point of the inverted microscope can be reduced by operating the other of the control buttons arranged in a pair.

The single control button 47 of second group 10₂ of the control buttons is formed as a so-called toggle switch. First pair 44 of the control buttons can be used to enlarge or reduce the aperture diaphragm of inverted microscope 1. Second pair 45 of the control buttons can be used to enlarge or reduce the field of view stop of the inverted microscope. Third pair 46 of the control buttons can be used to increase or reduce the light intensity. The single control knob 47 of second group 10₂ of the control buttons is used to switch back and forth between the different types of illumination for the microscope. To explain the function of first pair 44, of second pair 45 and third pair 46, each of them is assigned a wedge 50. Wedge 50 is placed in the immediate vicinity of first pair 44, second pair 45 and third pair 46 of the control buttons on first lateral face 3a of the inverted microscope. The point of the wedge indicates a reduction of the setting point, whereas the thick end of the wedge indicates an increase of the setting point.

FIG. 6 shows a detail view of third group 10₃ of the control buttons that are positioned on a rectangular plate 52 on front face 3c of base part 3 of the microscope. Rectangular plate 52 defines a first diagonal 53 and a second diagonal 54. A tactile element 55 of third group 10₃ of the control buttons is arranged at the intersection point of first diagonal 53 and second diagonal 54. Tactile element 55 is formed as a control button and is used for operating a shutter in inverted microscope 1. A first pair 56 of control buttons is arranged diagonally to the left above tactile element 55. First pair 56 of control buttons is used to switch between a plurality of ports of the microscope. A second pair 57 of control buttons is arranged diagonally to the right above tactile element 55. Second pair 57 of control buttons is used for switching between a magnification and/or reduction. Three control buttons 59 are arranged diagonally to the right below tactile element 55. Likewise, three control buttons 58 are arranged diagonally to the left below the tactile element. Each of control buttons 58 or 59 is used for the selection of a specific position of a filter cube. As already mentioned in the description for FIG. 4, a corresponding filter wheel (not shown) is provided behind flap 30 on the second lateral surface of the inverted microscope.

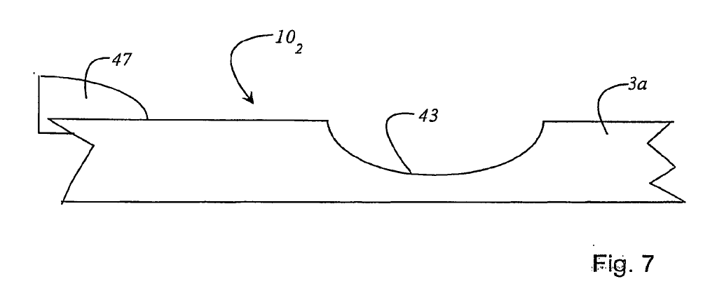

FIG. 7 shows a sectional view through tactile element 43, which is formed on first lateral face 3a of base part 3 of inverted microscope 1. Tactile element 43 has the shape of a spherical segment and is formed as a recess in lateral face 3a of inverted microscope 1. The user can sense tactile element 43 with a finger of the hand and in this way attain an orientation within second group 10₂ of the control buttons.

The invention was described in reference to a particular embodiment. However, it is obvious that changes and modifications can be made without departing in the process from the scope of protection of the claims listed below.

What is claimed is:

1-27. (canceled)

28. An inverted microscope (1) having a base stand part (3), which carries a lens turret (5) and a microscope stage, a lighting stand part (7) mounted to the base stand part (3), the base stand part (3) having a first lateral face (3a), a second lateral face (3b) and a front (3c) which in operation normally faces a user; a plurality of control buttons (10) for control of motorized microscope functions provided on the first and second lateral faces (3a, 3b) and the front face (3c), said control buttons (10) being arranged into a plurality of groups, each comprising a plurality of control buttons, wherein the control buttons (10) are brought together into a first group (10₁), a second group (10₂), a third group (10₃), a fourth group (10₄) and a fifth group (10₅), the control buttons of the second group (10₂) are arranged on the first lateral face (3a) around a tactile element (43) that serves as an orientation aid to the user, and the control buttons of the third group (10₃) are arranged on the front face (3c), likewise around a tactile element (55) that serves as an orientation aid to the user.

29. The inverted microscope of claim 28 wherein at least one focus knob is provided on a spindle axis (11) which axis may be considered to pass horizontally through the first and second lateral faces of the microscope stand

30. The inverted microscope (1) as described in claim 29, wherein the first group (10₁) comprises four control buttons, the first group (10₁) is arranged in an arc behind a focus drive knob (9) that is mounted on the spindle axis (11), and two of the four control buttons are arranged on the first lateral face (3a) above the spindle axis (11) and two of the control buttons are arranged on the first lateral face (3a) below the spindle axis (11).

31. The inverted microscope (1) as described in claim 29, wherein the fifth group (10₅) comprises three control buttons, the fifth group (10₅) is arranged in an arc behind a focus drive knob (9) mounted on the spindle axis (11), and two of the three control buttons are arranged on the second lateral face (3a) above the spindle axis (11) and one control button is arranged on the second lateral face (3a) below the spindle axis (11).

32. The inverted microscope (1) as described in claim 29, wherein the fourth group (10₄) comprises three control buttons, the fourth group (10₄) being arranged in a straight line and vertically in front of the focus drive knob (9) that is mounted on an axial spindle (11), and two of the three control buttons are arranged on the second lateral face below the spindle axis (11).

33. The inverted microscope (1) as described in claim 29, wherein the second group (10₂) of control buttons is mounted on the first lateral face (3a) in front of a focus drive knob (9) mounted on the spindle axis (11).

34. The inverted microscope as described in claim 28, wherein the tactile element (43) that is assigned to the second group (10₂) is formed as a recess.

35. The inverted microscope as described in claim 33, wherein the tactile element (43) that is assigned to the second group (10₂) is formed as a recess.

36. The inverted microscope as described in claim 34, wherein the recess has the shape of a spherical segment.

37. The inverted microscope as described in claim 34, wherein at least four control buttons are arranged in a cruciform configuration around the tactile element (43), at least two control buttons being arranged on a vertical leg (41) of the cross and two of the control buttons being arranged on a horizontal leg (42) of the cross.

38. The inverted microscope as described in claim 36, wherein on the horizontal leg (42) of the cross a first pair (44) of control buttons is arranged to the left of the tactile element (43) and a second pair (45) of control buttons is arranged to the right of the tactile element (43).

39. The inverted microscope as described in claim 36, wherein on the vertical leg (41) of the cross a third pair (46) of control buttons is arranged above the tactile element (43) and a single control button (47) is arranged below the tactile element (43).

40. The inverted microscope as described in claim 36 wherein a setting point for different microscope functions can be independently increased by operating one control button each of the first pair (44), the second pair (45) or the third pair (46) and the corresponding setting point can be decreased by operating another control button each of the first pair, the second pair or the third pair.

41. The inverted microscope as described in claim 39, wherein aperture size in an aperture diaphragm can be enlarged or reduced using the first pair (44) of control buttons.

42. The inverted microscope as described in claim 39, wherein a field of view stop can be enlarged or reduced using the second pair (45) of control buttons.

43. The inverted microscope as described in claim 39, wherein light intensity can be increased or reduced using the third pair (46) of control buttons.

44. The inverted microscope as described in claim 38, wherein the single control button (47) is a toggle switch that switches between different types of illumination for the microscope.

45. The inverted microscope as described in claim 28, wherein the control buttons of the third group (10₃) are arranged on the front face (3c) of the microscope within an essentially rectangular plate (52).

46. The inverted microscope as described in claim 44, wherein the tactile element (55) of the third group (10₃) is a control button that is arranged essentially in the area of the intersection point of the diagonals (53, 54) of the rectangular plate (52).

47. The inverted microscope as described in claim 45, wherein the tactile element (55) is a control button for a shutter.

48. The inverted microscope as described in claim 45, wherein a first pair (56) of control buttons is arranged diagonally to the left above the tactile element (55).

49. The inverted microscope as described in claim 47, wherein the first pair (56) of control buttons makes it possible to switch between a plurality of ports of the microscope.

50. The inverted microscope as described in claim 45, wherein a second pair (57) of control buttons is arranged diagonally to the right above the tactile element (55).

51. The inverted microscope as described in claim 49, wherein the second pair (57) of control buttons makes it possible to switch between magnification and/or reduction.

52. The inverted microscope as described in claim 45, wherein three control buttons (59) are arranged diagonally to the right below the tactile element (55).

53. The inverted microscope as described in claim 45, wherein three control buttons (58) are arranged diagonally to the left below the tactile element (55).

54. The inverted microscope as described in claim 51 wherein each of the control buttons is used for the selection of a filter cube at a specific position.

55. The inverted microscope as described in claim 53, wherein the filter cube is on a wheel having six positions for the filter cube.

56. The inverted microscope as described in claim 52 wherein each of the control buttons is used for the selection of a filter cube at a specific position.

57. The inverted microscope as described in claim 55, wherein the filter cube is on a wheel having six positions for the filter cube.

58. The inverted microscope as described in claim 28 wherein the base stand part below the third group (10₃) of the control buttons has a wedge-shaped extension (19) formed on the front face (3c) and a display (20) is incorporated in the wedge-shaped extension (19).

59. The inverted microscope as described in claim 57, wherein the display (20) is permanently installed and is tilted at an angle less than 45° relative to the placement surface (12) of the microscope.
